(19) United States
(12) Patent Application Publication
(10) Pub. No.: US 2023/0380440 A1
(43) Pub. Date: Nov. 30, 2023

(54) PACKAGED POPCORN CONFECTION, AND METHOD FOR MANUFACTURING SAME

(71) Applicant: PCO GROUP GMBH, DASSOW (DE)

(72) Inventors: STEFAN LEMKE, POGEEZ (DE); RAFAL WISNIEWSKI, KOSZALIN (PL)

(73) Assignee: PCO GROUP GMBH, DASSOW (DE)

(21) Appl. No.: 18/031,619

(22) PCT Filed: Aug. 31, 2021
(86) PCT No.: PCT/DE2021/200117

§ 371 Date: Apr. 13, 2023

(30) Foreign Application Priority Data
Oct. 16, 2020 (DE) 10 2020 127 345.2

(51) Int. Cl. A23G 3/54; A23L 7/191; A23P 20/18

(52) U.S. Cl. CPC A23G 3/54; A23L 7/191; A23P 20/18

(57) ABSTRACT

A packaged popcorn confection includes a container, a popcorn layer of a prepared popcorn in the container, a coating that covers a part of a top of popcorn layer and which holds together the popcorn layer, and a foil bag which encloses the container, the popcorn layer, and the coating in an airtight manner. The coating includes a couverture that is flowable when heated and solid when cooled and/or and a solidified glaze.

### CROSS REFERENCE TO PRIOR APPLICATIONS

This application is a U.S. National Phase application under 35 U.S.C. § 371 of International Application No. PCT/DE2021/200117, filed on Aug. 31, 2021 and which claims benefit to German Patent Application No. 10 2020 127 345.2, filed on Oct. 16, 2020. The International Application was published in German on Apr. 21, 2022 as WO 2022/078555 A1 under PCT Article 21(2).

### FIELD

The present invention relates to a packaged popcorn confection and to a method for manufacturing a packaged popcorn confection for sale in supermarkets, shops or on online platforms.

### BACKGROUND

Popcorn is usually consumed in freshly prepared form, but it is also common to package freshly prepared popcorn in airtight foil bags so that the popcorn retains its crunchy texture until consumed. To give the popcorn a caramel or chocolate flavor, for example, it is also known to stir the freshly prepared popcorn together with heated caramel or heated chocolate into a container to provide the individual popcorn flakes or balls with a caramel or chocolate coating. The popcorn flakes, coated with caramel or chocolate over their entire surface, are then cooled with further stirring to separate them after the coating has cooled and hardened, and packaged in a predetermined quantity in a foil bag. An example of such a packaged popcorn confection is the popcorn confection marketed under the name Crunchy Popcorn.

One disadvantage of this type of popcorn confection is that the popcorn confection can only be presented inadequately visually to the consumer when removed from the foil bag, whereas visual appearance plays an increasingly important role in purchase decisions.

### SUMMARY

An aspect of the present invention is to provide a popcorn confection and a method for manufacturing the popcorn confection where the popcorn confection can be well presented visually when removed from the packaging and where the popcorn confection is in no way inferior to known popcorn confections in terms of taste and feel.

In an embodiment, the present invention provides a packaged popcorn confection which includes a container, at least one popcorn layer of a prepared popcorn in the container, a coating that covers a part of a top of the at least one popcorn layer and which holds together the at least one popcorn layer, and a foil bag which encloses the container, the at least one popcorn layer, and the coating in an airtight manner. The coating comprises at least one of a couverture that is flowable when heated and solid when cooled, and a solidified glaze.

### BRIEF DESCRIPTION OF THE DRAWINGS

The present invention is described in greater detail below on the basis of embodiments and of the drawings in which:

FIG. 1 shows a top side view of an empty container for packaging popcorn confection;

FIG. 2 shows a longitudinal side view of the container;

FIG. 3 shows a front side view of the conveyor;

FIG. 4 shows a plan view of the container after it has been filled with a layer of popcorn;

FIG. 5 shows a plan view of the container after applying the couverture to the popcorn layer according to a first embodiment;

FIG. 6 shows a plan view of the container after applying the couverture to the popcorn layer according to a second embodiment;

FIG. 7 shows a plan view of the container after applying the couverture to the popcorn layer according to a third embodiment;

FIG. 8 shows a plan view of the container after sprinkling particles of an edible sprinkling product onto the popcorn layer and couverture of the first embodiment before packaging the popcorn confection in a foil bag;

FIG. 9 shows a view corresponding to FIG. 3, but without the foil bag;

FIG. 10 shows a schematic side view of part of a device for manufacturing the popcorn confection; and

FIG. 11 shows a side view of the device in FIG. 10.

### DETAILED DESCRIPTION

The present invention provides a packaged popcorn confection which comprises a container, a layer of prepared popcorn in the container, and a coating made of a couverture that is flowable when heated and solid when cooled, and/or made of a solidified glaze, that covers part of the top of the popcorn layer and holds together the popcorn layer. The container with the popcorn layer partially coated with couverture and/or glaze is enclosed in a gas-tight foil bag to preserve the crunchy texture of the freshly prepared popcorn.

The popcorn in a container can thereby in particular be “fixed” as the coating (glaze) binds the individual popcorn flakes together. This also prevents popcorn flakes from falling out of the container in an undesirable way when consumed.

In the context of the present patent application, a glaze is a flowable mass made from sugar, in particular icing sugar, and a water-containing liquid, such as water, fruit juice and/or fresh protein, which solidifies on drying.

In the context of the present patent application, a couverture is a mass produced from sugar, in particular icing sugar, and one or more animal and/or vegetable fat-containing products, such as butter, soya oil, chocolate, milk powder, cocoa powder and/or cocoa butter, which becomes flowable or liquid when heated and which solidify when cooled.

The container with contents can be removed from the foil bag for consumption, whereby the contents of the container are presented in a visually appealing way because the couverture and/or glaze largely holds together the popcorn layer during transport and storage and counteracts any relative movement of the individual popcorn flakes within the layer, for example, if the packaged popcorn confection is tilted or if a box filled with foil bags is flipped during transport.

The layer of prepared popcorn in the container can, for example, be single-layered or at most two-layered, as the couverture and/or glaze applied to the top of the popcorn layer essentially holds together the top layer, while in the layers below, cohesion is only provided to the extent that the couverture and/or glaze penetrates therein.

The popcorn in the popcorn layer can be unprocessed popcorn, which advantageously does not need to be crushed before use. Processed popcorn is, however, advantageously used, for example, sweetened popcorn or caramel-coated or chocolate-coated popcorn, wherein the latter may also help to improve the cohesion of the popcorn layer by heating the chocolate-coated or caramel-coated popcorn before, during or after the application of the couverture and/or glaze.

A design of the present invention provides that the coating can, for example, consist of a sweet chocolate couverture or a sweet or salted caramel couverture, as these taste particularly good with the popcorn, but are also sufficiently stable when cooled to keep the popcorn layer together to a large extent even if the packaged popcorn confection is tilted or flipped during transport.

It is also alternatively or additionally possible, however, to use a glaze or icing or the like as a coating that is flowable when applied and solidifies after some time, thus achieving a similar result.

An additional protection of the popcorn confection against damage during handling, e.g., during transport or storage, is achieved by the container which is advantageously in the shape of a flat tray with a base and circumferential with outwardly sloping edges projecting upwards from the base.

As further protection for the contents, to improve the stability of the container, and also to improve the visual appearance before consumption, an outwardly projecting ridge is advantageously provided at the upper edge of the side walls, which can also be advantageous when unstacking the empty containers and placing the filled containers in the foil bag. To provide that the container with the popcorn layer and the chocolate coating can be easily packaged in the foil bag, the container advantageously has a rectangular outline in plan view.

While the container is conveniently folded from a blank of paper, cardboard or paperboard, or alternatively formed from bagasse (sugar cane residue), the foil bag can, for example, consist of a gas-tight or largely gas-tight foil so that the popcorn in the bag remains crunchy even during prolonged storage.

The coating of couverture and/or glaze can, for example, extend over the top of the popcorn layer in the form of linear, striped or patchy patterns so that the coating of couverture and/or glaze partially covers the top of the popcorn layer. The patterns can, for example, be wavy lines, zigzag lines, loops, circles or hearts or irregular patterns.

To further enhance both the aesthetic appearance of the popcorn confection before consumption and the taste experience when consumed, the present invention also provides that particles of at least one edible sprinkling product can, for example, be distributed on the popcorn layer and the coating of couverture and/or glaze, wherein the particles advantageously adhere to the coating and/or lie in recesses of the popcorn layer so that they predominantly retain their position even if the packaged popcorn confection is tilted or if a box filled with film bags is flipped during transport.

The particles can advantageously be chopped nuts, peanuts or almonds, nut or almond flakes, coconut shavings, small colorful sweets such as sugar-coated chocolate sweets, chocolate sprinkles, chocolate rolls, chocolate stars or sugar sprinkles, hard sugar sweets, sugar stars, sugar hearts, sugar unicorns, small gummy bears or jelly beans or the like.

The method for manufacturing a packaged popcorn confection from popcorn and a couverture that is flowable when heated and solid when cooled and/or a solidifying glaze, comprises the following steps:
preparing popcorn by popping the popping corn;
providing a container;
filling the container with a layer of the popcorn;
applying the heated couverture and/or the glaze in a flowable state to the top of the popcorn layer so that the couverture and/or the glaze partially covers the popcorn layer;
cooling the couverture or solidifying the glaze, thereby forming a solid coating that holds the popcorn layer together in the container; and
packaging the container with the popcorn layer and the coating in a gas-tight foil bag.

If the heated couverture and/or glaze are applied to the top of the popcorn layer in a flowable or liquid state, the couverture and/or glaze will moisten the popcorn flakes and adhere to them as they cool or solidify. Due to the low weight of the popcorn flakes, both the adhesion of the couverture and/or the glaze to the popcorn flakes and the internal cohesion of the cooled couverture and/or the solidified glaze are great enough to prevent the couverture or glaze from peeling off the popcorn flakes and the cooled couverture or solidified glaze from breaking between neighboring popcorn flakes, thus preventing the popcorn flakes from moving relative to each other if, for example, the packaged popcorn confection is tilted or if a box filled with foil bags is flipped during transport.

An advantageous design of the method according to the present invention provides that particles of at least one edible sprinkling product are distributed on the popcorn layer and the coating of the couverture and/or the glaze that has not yet cooled or solidified, so that at least some of the particles adhere to the coating.

The application of the couverture and/or glaze and the particles of the at least one edible sprinkling product to the popcorn layer can, for example, be performed by moving the containers with the popcorn layer on a conveyor under an applicator device and immediately thereafter under a sprinkling device, wherein in the applicator glaze and/or heated couverture is applied in a flowable state to the top of the popcorn layer, and wherein in the sprinkling device the particles are sprinkled from above onto the popcorn layer and onto the not yet cooled couverture and/or not yet solidified glaze.

The present invention is explained in greater detail under reference to exemplary embodiments as shown in the drawings.

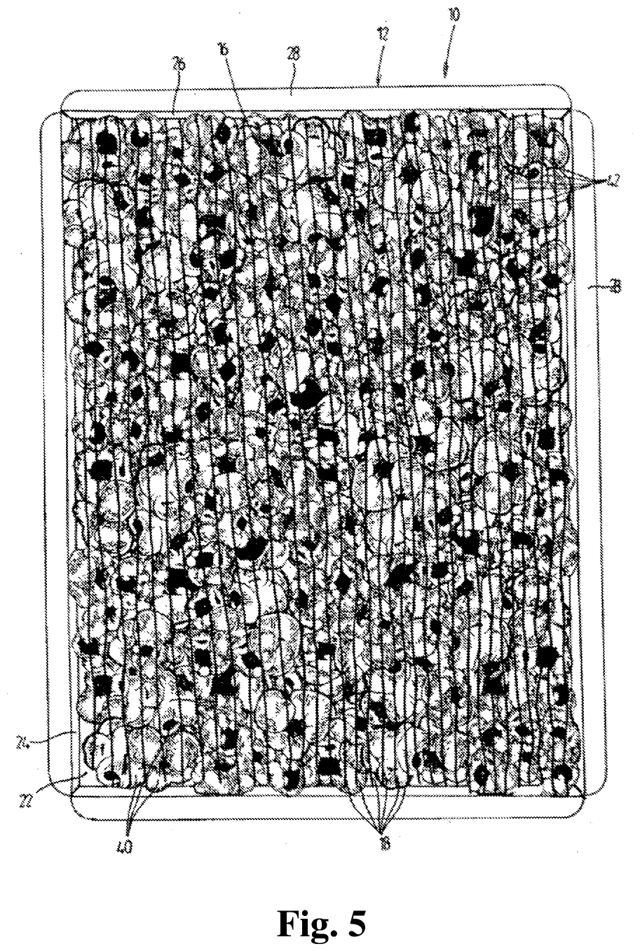

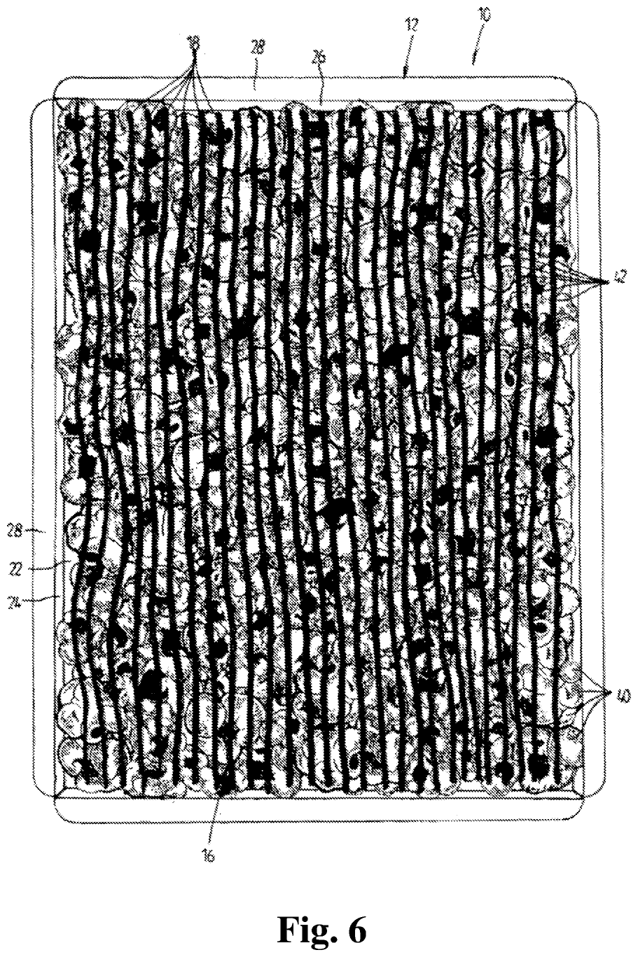

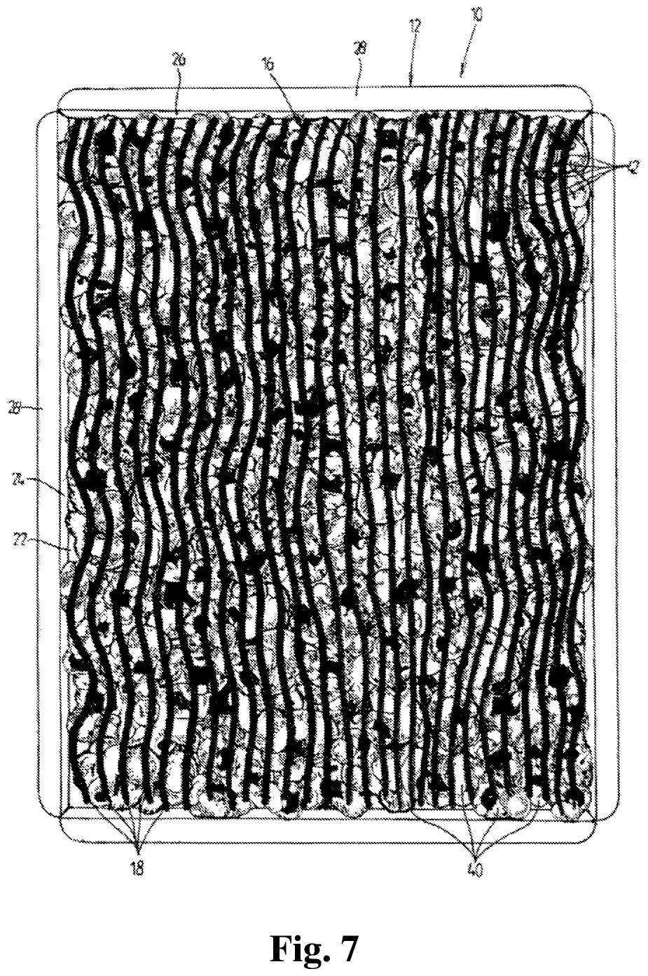

The partly packaged popcorn confection 10 shown in FIGS. 5 to 8 essentially consists of a flat container 12, a popcorn layer 14 of prepared popcorn in the container 12, a coating 16 made of a couverture 18 that is flowable when heated and solid when cooled, and possibly particles 20 of an edible sprinkling product. The finished popcorn confection 10 is packaged in a thin gas-tight foil bag 38 made of an aluminum-coated or vapor-deposited plastic foil 64.

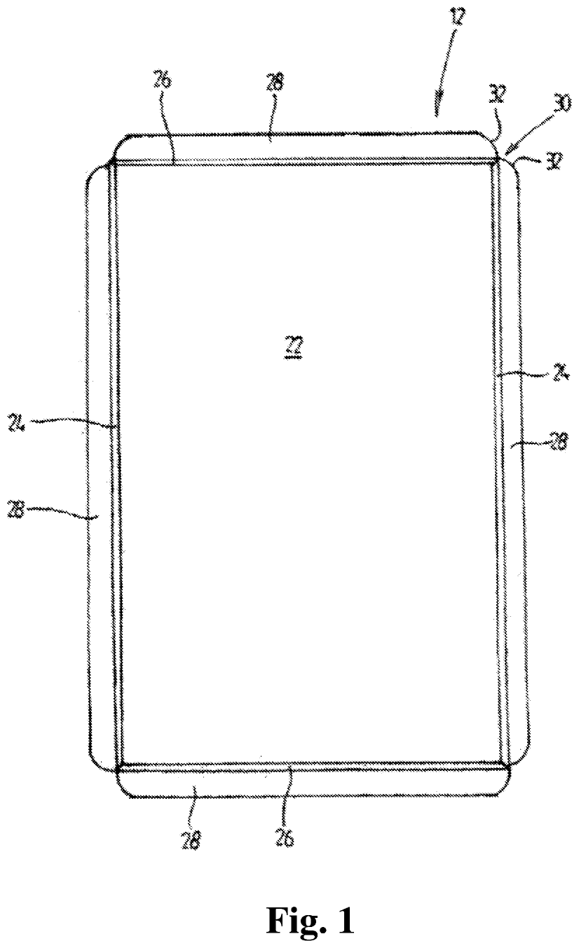

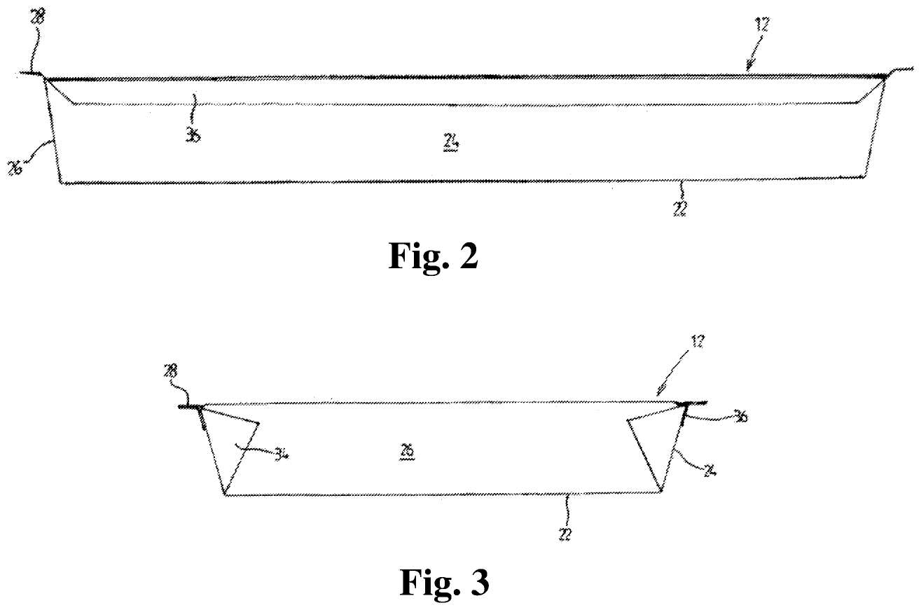

As best seen in FIGS. 1 to 3, the container 12 is made by folding a one-piece blank of cardboard which is in the form of a flat tray having a base 22, and four side walls 24, 26 integrally connected to the base 22 and projecting upwardly and outwardly from the base at an angle of about 75 degrees, the upper edges of the side walls 24, 26 are parallel to one another in pairs. A ridge 28 projects outwardly from the upper edge of each side wall 24, 26, aligned parallel to the base 22 and having rounded ends 32 at the corners 30 of the container 12. A double-layer pocket 34 is formed between each two adjacent side walls 24, 26 when the container is folded, and is bonded to the adjacent shorter side wall 26 against it, as is shown in FIG. 3. In order to provide greater rigidity to the container 12 in the longitudinal direction, the ridges 28 are double-layered at the upper edges of the longer side walls 24, wherein each of their outer edges 36 are folded downwards, resting from the outside against an upper edge strip of the adjacent side wall 24 and are bonded thereto, as shown in FIGS. 2 and 3.

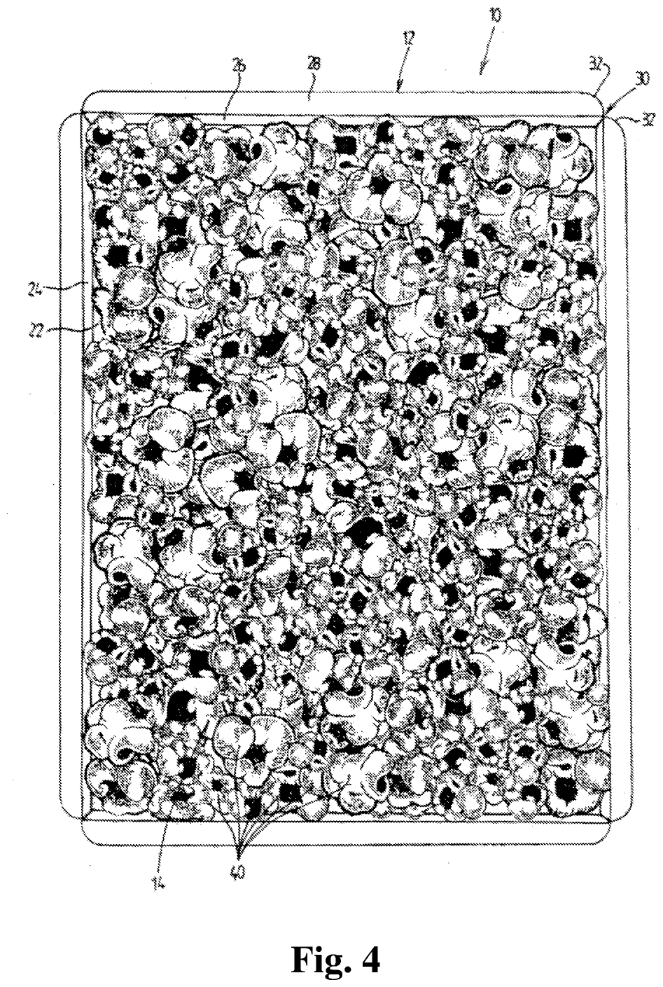

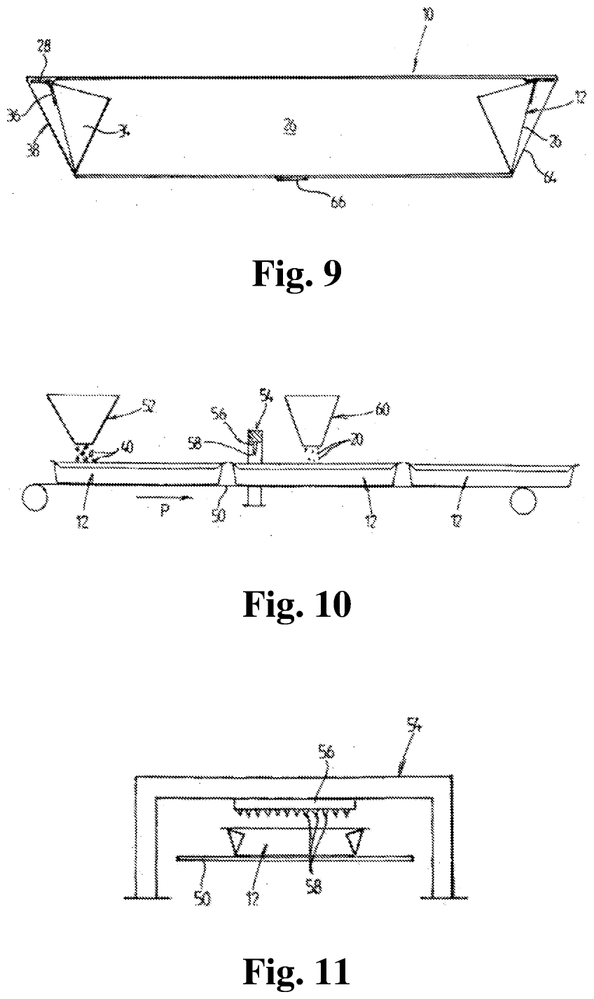

The popcorn layer 14 consists of individual, for example, freshly prepared popcorn flakes 40, which lie in a single layer close to one another with as few gaps as possible on the base 22 of the container 12 and which cover the base 22 completely, as is best shown in FIG. 4. The popcorn layer 14 extends upwards, not beyond the ridge 28 at the upper edge of the side walls 24, 26, as is shown in FIG. 9.

As shown in FIGS. 5 to 8, the coating 16 of couverture 18 is in the form of a plurality of stripes or strips 42 extending over and partially covering the top of the popcorn layer 14. In the drawings, the stripes or strips 42 run generally in the direction of the longitudinal axis of the container 12. The coating 16 can also, however, consist of a plurality of individual, closely spaced apart, irregularly distributed patches or a combination of patches and strips or stripes, which may also extend in other and/or alternating directions across the top of the popcorn layer 14, such as in loops, zigzags or irregular patterns. It is in principle even possible to apply strips in the shape of a heart or with another shape to the top of the popcorn layer 14. The width of the individual stripes or strips 42 or patches, and the spacing of adjacent stripes or strips 42 or patches, is such that the popcorn flakes 40 of the popcorn layer 14 are largely held together by the couverture 18 and individual popcorn flakes 40 do not become dislodged from the bond of the popcorn layer 14 when the container 12 is tilted.

In the first and second embodiments, the stripes or strips 42 are generally rectilinear and parallel to the longer side walls 24, whereas in the third embodiment they are wavy.

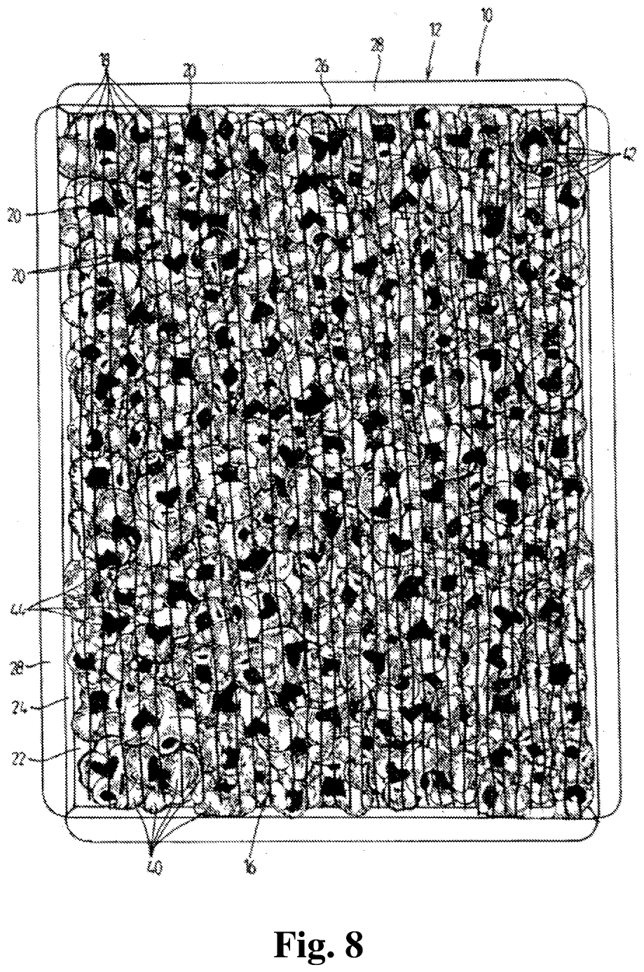

The particles 20 of the edible sprinkling product, which are only shown in the embodiment in FIG. 8, are small chocolate hearts 44, which are commercially available. The chocolate hearts 44 partially adhere to the chocolate coating 16 and partially lie in depressions between adjacent popcorn flakes 40. Other small sweets, such as sugar-coated chocolate sweets, chocolate sprinkles, chocolate stars, chocolate rolls or sugar sprinkles, hard sugar sweets, sugar stars, sugar hearts, sugar unicorns, small gummy bears or jelly beans can of course also be sprinkled as a sweet edible sprinkling product on the popcorn layer 14 coated with the chocolate coating as the couverture 18, to name just a few examples. Chopped nuts, chopped peanuts or chopped almonds, nut flakes, almond flakes or coconut shavings can also be used as sprinkles.

To manufacture the popcorn confection 10, popcorn is freshly prepared by popping the popping corn and then filled the popcorn into one of the pre-made containers 12. As shown in FIGS. 10 and 11, the container 12 is moved on a conveyor 50 under a metering device 52, which meters a predetermined amount of popcorn into the container 12 and distributes it there in the form of a single popcorn layer 14.

The container 12 is then moved by the conveyor 50 in the direction of the arrow P in FIG. 10 under a gantry 54 with a couverture applicator 56. The applicator 56 has a plurality of side-by-side, downwardly directed bottom spray nozzles 58 to which heated flowable couverture is supplied under pressure to be applied in a plurality of stripes or strips 42 side-by-side to the top of the popcorn layer 14 so that the couverture stripes or strips 42 partially cover the popcorn layer 14.

The container 12 can alternatively be moved from the conveyor 50 under another couverture and/or glaze applicator (not shown) which is movable relative to the conveyor 50 both in the conveying direction (arrow P) and transversely to the conveying direction P and which also has a plurality of downwardly directed spray nozzles. The conveyor 50 is then stopped and the applicator 56 is moved back and forth in the conveying direction P and transversely over the container 12 while flowable couverture or/and glaze is fed under pressure into the spray nozzles 58 to be applied to the top of the popcorn layer 14. Depending on the movement pattern of the applicator 56, the couverture and/or glaze is applied to the popcorn layer 14 in loops, zigzags or other patterns so that the popcorn layer 14 is then also partially covered by the coating of couverture and/or glaze.

Immediately downstream of the gantry 54 containing the applicator 56, or immediately downstream of the other couverture and/or glaze applicator, a sprinkling device is arranged from which particles 20 of the edible sprinkling product are sprinkled from above onto the popcorn layer 14, which is partially coated with couverture 18 and/or glaze. Due to the small distance from the applicator 56, at least the particles 20 coming into contact with the couverture 18 and/or glaze remain attached to the still warm and thus somewhat sticky couverture 18 or to the not yet solidified glaze.

After the couverture 18 has cooled or the glaze has solidified, the popcorn confection 10 is packaged in an airtight manner by placing the aluminum vaporized or coated gas-tight plastic foil 64 around the container 12 and sealing the container 12 in the plastic foil 64 in a gas-tight manner. The opposite edges of the plastic foil 64 are thereby first welded to the underside of the container 12 along a longitudinal weld 66 parallel to the longer side walls 24, before the foil tube formed in the process is welded between adjacent containers 12 along two transverse welds (not shown) parallel to the shorter side walls 26 and cut to form the foil bags 38.

As the containers 12 are further transported, or as the packaged popcorn confection is packaged and stacked in the foil bags 38, the particles 20 not adhering to the couverture 18 and/or the glaze slide into the recesses between adjacent popcorn flakes 40, where they come to rest.

In the event that not all of the popcorn confection 10 is to be consumed after opening the foil bag 38, it can be heated in an oven for a short time. After cooling, and once the couverture 18 has cooled down, the popcorn in the popcorn confection 10 will again have its original consistency.

The present invention is not limited to embodiments described herein; reference should be had to the appended claims.

### LIST OF REFERENCE NUMERALS

10 Popcorn confection
12 Container
14 Popcorn layer
16 Coating
18 Couverture
20 Particles
22 Base
24 Side wall
26 Side Wall
28 Ridge
30 Corner
32 End
34 Double-layer pocket
36 Outer edge
38 Foil bag
40 Popcorn flakes
42 Stripes or strips
44 Chocolate heart
50 Conveyor
52 Metering device
54 Gantry
56 Applicator
58 Spray nozzle
60 Sprinkling device
64 Plastic foil
66 Longitudinal weld
P Conveying direction

What is claimed is:

1-15. (canceled)

16. A packaged popcorn confection comprising:
a container;
at least one popcorn layer of a prepared popcorn in the container;
a coating that covers a part of a top of the at least one popcorn layer and which holds together the at least one popcorn layer, the coating comprising at least one of,
a couverture that is flowable when heated and solid when cooled, and
a solidified glaze; and
a foil bag which encloses the container, the at least one popcorn layer, and the coating in an airtight manner.

17. The packaged popcorn confection as recited in claim 16, wherein the at least one popcorn layer in the container comprises a maximum of one popcorn layer or two popcorn layers.

18. The packaged popcorn confection as recited in claim 16, wherein the couverture is a sweet chocolate couverture, a sweet caramel couverture, or a salted caramel couverture.

19. The packaged popcorn confection as recited in claim 18, wherein at least one of the couverture and the solidified glaze partially covers the top of the at least one popcorn layer in a linear form, a striped form, a patchy form, or as a form having irregular patterns.

20. The packaged popcorn confection as recited in claim 16, further comprising:
particles comprising at least one edible sprinkling product,
wherein,
the at least one popcorn layer has depressions,
the particles are distributed on the at least one popcorn layer and on the coating, and
the particles at least one of adhere to the coating and lie in the depressions of the at least one popcorn layer.

21. The packaged popcorn confection as recited in claim 20, wherein the particles are at least one of chopped nuts, chopped almonds, nut flakes, or almond flakes.

22. The packaged popcorn confection as recited in claim 20, wherein the particles are colorful sweets.

23. The packaged popcorn confection as recited in claim 16, wherein the container has a substantially rectangular outline or a substantially square outline in a plan view.

24. The packaged popcorn confection as recited in claim 16, wherein the container is folded from a blank of paper, a blank of cardboard, or a blank of paperboard, or is formed from a bagasse.

25. The packaged popcorn confection as recited in claim 16, wherein the container comprises a base, side walls which each comprise an upper edge, and a ridge on the upper edge of the side walls which are parallel to the base.

26. A method of manufacturing a packaged popcorn confection for popcorn and at least one of a couverture that is flowable when heated and solid when cooled and a glaze which is flowable and which solidifies, the method comprising:
providing a container;
filling the container with a popcorn layer of the popcorn;
applying at least one of the couverture which has been heated to a flowable state and the glaze in a flowable state to a top of the popcorn layer so that the at least one of the couverture and the glaze partially cover the popcorn layer;
forming a solid coating which covers and holds together a part of the popcorn layer in the container by at least one of cooling the couverture and solidifying the glaze; and
packaging the container with the popcorn layer and the coating in a gas-tight foil bag.

27. The method as recited in claim 26, wherein, prior to forming the solid coating which covers and holds together the part of the popcorn layer in the container by at least one of cooling the couverture and solidifying the glaze, the method further comprises:
distributing particles of at least one edible sprinkling product on the popcorn layer and on at least one of the couverture which has not yet cooled and the glaze which has not yet solidified so that at least some of the particles adhere thereto.

28. The method as recited in claim 26, wherein the applying of at least one of the couverture which has been heated to the flowable state and the glaze in the flowable state to the top of the popcorn layer so that the at least one of the couverture and the glaze partially cover the popcorn layer is performed by moving the container with the popcorn layer on a conveyor under an applicator from which at least one of the couverture which has been heated to the flowable state and the glaze in the flowable state is applied to the top of the popcorn layer.

29. The method as recited in claim 28, wherein,
the applicator is moved in at least one of a conveying direction and transversely to the conveying direction with respect to the container so as to apply at least one of the couverture and the glaze to the top of the popcorn layer so as to form a coating in a linear pattern, a striped pattern, a patchy pattern or as an irregular pattern, which run in a same direction or in a different direction, respectively, and
the coating is at least one of cooled and solidified so as to form the solid coating.

30. A packaged popcorn confection which is manufactured via the method as recited in claim 26.
